(19) United States
(12) Patent Application Publication
(10) Pub. No.: US 2014/0034193 A1
(43) Pub. Date: Feb. 6, 2014

(54) Method for Producing a Grain-Oriented Flat Steel Product

(71) Applicants: Eyup Duman, Yildiz-Cankaya (TR); Christof Holzapfel, Gelsenkirchen (DE); Thorsten Krenke, Duisburg (DE); Ludger Lahn, Moers (DE); Régis Lemaitre, Bethune (FR); Chaoyong Wang, Dortmund (DE); Thierry Belgrand, Hinges (FR)

(72) Inventors: Eyup Duman, Yildiz-Cankaya (TR); Christof Holzapfel, Gelsenkirchen (DE); Thorsten Krenke, Duisburg (DE); Ludger Lahn, Moers (DE); Régis Lemaitre, Bethune (FR); Chaoyong Wang, Dortmund (DE); Thierry Belgrand, Hinges (FR)

(73) Assignee: THYSSENKRUPP ELECTRICAL STEEL GMBH, Gelsenkirchen (DE)

(21) Appl. No.: 13/984,308

(22) PCT Filed: Sep. 22, 2011
(86) PCT No.: PCT/EP2011/066512

§ 371 Date: Oct. 22, 2013

(30) Foreign Application Priority Data
Feb. 14, 2011 (DE) 10 2011 000 712.1

(51) Int. Cl. H01F 41/00

(52) U.S. Cl. CPC H01F 41/00
USPC 148/121

(57) ABSTRACT

The present invention relates to a method for producing a grain-oriented flat steel product that is intended for the manufacture of parts for electrotechnical applications and has minimised magnetic loss values and optimised magneto-restrictive properties, including the operations providing a flat steel product, laser-treating the flat steel product, wherein, in the course of the laser treatment, linear deformations, which are arranged with a spacing L, are formed into the surface of the flat steel product by means of a laser beam emitted by a laser beam source with a power P. The method according to the invention for producing flat steel products is optimally suited for the manufacture of parts for transformers.

The invention relates to a method for producing a grain-oriented flat steel product having minimised magnetic loss values and optimised magnetostrictive properties.

The grain-oriented flat steel products in question, known in technical jargon as “HGO material”, are steel strips, known as “electrical steel strips”, or steel sheets known as “electrical steel sheets”. Parts for electrotechnical applications are manufactured from flat steel products of this type.

Grain-oriented electrical steel strips or sheets are suitable in particular for uses in which a particularly low remagnetisation loss is key and in which there are high requirements in terms of permeability or polarisation. These types of requirements occur in particular in parts for power transformers, distribution transformers and high-quality small transformers.

As described in detail for example in EP 1 025 268 B1, generally in the course of the manufacture of flat steel products initially a steel which is (in percent by weight) typically 2.5 to 4.0% Si, 0.010 to 0.100% C, up to 0.150% Mn, up to 0,065% Al and up to 0.0150% N, in addition to optionally 0.010 to 0.3% Cu, up to 0.060% S, up to 0.100% P, up to 0.2% respectively As, Sn, Sb, Te and Bi, residual iron and unavoidable impurities is cast as a primary material such as a slab, thin slab or a cast strip. The primary material is then necessarily subject to an annealing treatment in order to then be hot rolled into a hot strip.

After the winding and an optionally additionally carried out annealing and a likewise optionally carried out descaling and pickling treatment, a cold strip is then rolled from the hot strip in one or a plurality of steps, wherein if necessary an intermediate annealing may be carried out between the cold rolling steps. In the decarbonisation annealing carried out as a result, the carbon content of the cold strip is normally decreased considerably in order to avoid magnetic ageing.

After the decarbonisation annealing, an annealing separator which is typically MgO is placed on the surface of the strip. The annealing separator prevents the windings of a coil rolled from the cold strip adhering to one another in the subsequent high temperature annealing. In the course of the high temperature annealing, which is typically carried out in a bell furnace in inert gas, the texture occurs in the cold strip as a result of selective grain growth. A forsterite layer forms in addition on the surfaces of the strip, known as a “glass film”. Furthermore, the steel material is purified through the diffusion processes which occur in the course of high temperature annealing.

Following the high temperature annealing, the flat steel product which has been obtained in this way is coated with an insulation layer, thermally straightened and stress relief annealed in a subsequent “final annealing”. This final annealing can take place before or after the assembly of the flat steel products produced in the manner described above to form the blanks needed for further processing, wherein the additional stresses which has arisen in the course of the division process may be released by means of a final annealing after the division of the blanks. Flat steel products produced in this way generally have a thickness of 0.15 mm to 0.5 mm.

The metallurgic properties of the material, the degree of deformity of the cold rolling processes set when producing the flat steel products and the parameters of the hot treatment steps are each adapted to one another such that the targeted re-crystallisation processes occur. These re-crystallisation processes lead to the “Goss-texture” typical for the material, in which the direction of easiest magnetisability is in the direction of rolling of the completed strips. Accordingly, grain-oriented flat steel products have strongly anisotropic magnetic behaviour.

There are various methods for improving the remagnetisation losses of a grain-oriented flat steel product. For example, the orientation sharpness of the Goss-texture of the flat steel product can be improved. Additional decreases in the loss can be achieved by decreasing the distances between the 180° domain walls. High tensile stresses in the direction of rolling, which are transferred via insulating layers on the surface of the steel, also contribute to a reduction in the distances between domains and therefore also to a reduction of the remagnetisation losses. However, the necessary tensile stress values can only be realised to a limited extent for technical reasons.

An additional possibility for reducing the losses suggested for example in DE 18 04 208 B1 or EP 0 409 389 A2 is that partially plastic deformities can be generated on the surface of the flat steel product. This can be achieved for example through mechanical scratching or piercing of the surfaces of the relevant flat steel products. The significant improvements in magnetic properties achieved in this way have the disadvantage that the mechanical processing of the surface damages the insulating layer placed on the flat steel products. This can, for example in the case of producing transformer plates from a flat steel product of this type, lead to short circuits in the stacked core of the transformer and to local corrosion.

Attempts to utilise the advantages of the mechanical scratching or piercing without destroying the insulation have focused on the use of laser sources (EP 0 008 385 B1, EP 0 100 638 B1, EP 1 607 487 A1). What the methods based on the use of lasers have in common is that a laser beam focuses on the surface of the flat steel product to be treated, generating thermal tension in the basic material. This leads to the formation of dislocations at which components of the magnetic flow escape from the surface of the flat steel product. The magnetic stray field energy hereby locally increases and “final domains” are formed to compensate for this, which are also known as “secondary structures”. At the same time there is a reduction in the distance between the main domains.

Since the abnormal remagnetisation loss depends on the distance between the main domains, the losses are minimised by appropriate laser treatment. The laser treatment can be used to improve the remagnetisation loss of a grain-oriented flat steel product with a nominal thickness typical for this product of 0.23 mm by more than 10% compared to the untreated state. The improvements in loss depend on both the properties of the basic material, such as the grain size and the texture sharpness and on the laser parameters, which include the spacing L of the lines along which the laser beams are guided on each of the flat steel products, the dwell time t_{dwell} and the specific energy density Uₛ. The coordination of these parameters has a decisive influence on the reduction of remagnetisation losses achieved in each case.

In addition to the remagnetisation losses, the production of noise also plays a role in transformers. This is based on a physical effect known as magnetostriction.

Magnetostriction is the changing of the length of a ferromagnetic material in the direction of its magnetisation. Operating a ferromagnetic component such as, for example, a transformer, in an alternating magnetic field will shift the 180° main domains, which by itself does not contribute to magnetostriction. However, there are magnetostrictive tensions in the material on the transitions from the 180° main domains to the 90° final domains. When operated in an alternating magnetic field, these form a source of noise and are the cause of noises in the transformers.

Introducing additional 90° final domains, in other words secondary structures, by means of laser treatment generally leads to an increase in magnetostriction and therefore the noise emissions, in particular when operating a transformer.

The requirements which are made in terms of minimising the production of noise when operating transformers are continuously increasing. On the one hand, this is due to legal guidelines and standards which are being continuously tightened. On the other hand, consumers generally no longer accept electrical devices with an audible buzz from the transformer. The acceptance from large transformers in the proximity of residential areas is therefore hugely dependent on the noise emissions which arise in the course of operation of transformers of this type.

A number of laser treatment processes have been suggested with which both improvements in loss and better magneto-restrictive properties can be achieved by selecting the appropriate process parameters (DE 601 12 357 T2/EP 1 154 025 B1, DE 698 35 923 T2/EP 0 897 016 B1, EP 2 006 397 A1, EP 1 607 487 A1). However, the optimisation of the parameters of the laser treatment is only carried out with a view to improving the remagnetisation losses.

Against the background of the prior art set out above, the object of the invention was to set out a method for producing flat steel products which are optimally suited for the manufacture of parts for transformers.

This object is achieved according to the invention by carrying out work steps set out in Claim 1 for the production of a flat steel product.

Advantageous embodiments of the invention are given in the dependent claims and are explained in greater detail below along with the general concept of the invention.

In accordance with the prior art set out above, a method according to the invention for producing a grain-oriented flat steel product with minimised magnetic loss values and optimised magneto-restrictive properties comprises the work steps:
a) Providing a flat steel product,
and
b) Laser-treating the flat steel product, wherein, in the course of the laser treatment, linear deformations, which are arranged with a spacing L, are formed into the surface of the flat steel product by means of a laser beam emitted by a laser beam source with a power P.

There are no particular requirements in terms of the manner of the manufacture of the flat steel product provided according to work step a). In this way, the flat steel products provided for the method according to the invention can be manufactured using the measures generally known by the person skilled in the art and summarised at the beginning and taking as a basis suitable steel alloys which are also sufficiently known from the prior art. This of course also includes those manufacturing processes and alloys which are not yet known.

According to the invention, the parameters of the laser treatment (work step b)) are now set such that a flat steel product produced according to the invention not only has minimised remagnetisation losses, but its apparent power S_{1.7/50 AFTER} given after the laser treatment is also optimised.

To this end, the apparent power S_{1.7/50}, emitted at a frequency of 50 Hertz and a polarisation of 1.7 Tesla, of the flat steel product to be treated with the laser beam is measured before and after treatment (operation b)) according to the invention.

Depending on the difference between the apparent power S_{1.7/50 BEFORE} measured before the laser treatment and the apparent power S_{1.7/50 AFTER} measured after the laser treatment, the parameters of the laser treatment are then varied such that the difference between the apparent powers S_{1.7/50} measured before and after the laser treatment is less than 40%.

According to the invention, the parameters of the laser treatment are therefore set such that an increase to the apparent power S_{1.7/50} of a flat steel product processed according to the invention set in the course of the laser treatment is limited by the setting the parameters of the laser treatment such that the apparent power S_{1.7/50 AFTER} measured after the laser treatment meets the following conditions:

S_{1.7/50 AFTER}<1.4×S_{1.7/50 BEFORE}

The increase in the apparent power caused by the laser treatment is, according to the invention, correspondingly limited such that the apparent power after lasering is not increased by more than 40% compared with its value on the same work piece before lasering.

The invention therefore takes into consideration that in the design of transformers the focus is generally not on the remagnetisation losses of each of the processed flat steel products but rather on the apparent power. According to the invention, the parameters of the laser treatment are not only optimised in terms of the remagnetisation losses but also in terms of the apparent powers at identical polarisation.

The subject matter of the method according to the invention is therefore an optimisation of the laser parameters in terms of minimising the remagnetisation losses P_{1.7/50} and the apparent power S_{1.7/50}. It transpires that minimising the apparent power also minimises the increase in noise. This means that the laser treatment mainly refines the main domains which leads to the desired minimisation of loss, but also as a result of the optimisation of the laser treatment according to the invention achieves a comparably low increase in the volume levels with magnetic secondary structures in terms of an apparent power which is as low as possible.

In principle, it is conceivable to carry out the laser treatment on electric sheets or sheet sections. It has proven to be particularly practical when a flat steel product present as a strip material is processed such that the laser treatment runs continuously.

If the relevant apparent power S_{1.7/50} before and after the continuous laser treatment is measured online and the parameters of the laser treatment are varied online depending on the difference between the apparent powers S_{1.7/50} measured, changes to the results of the laser treatment can be reacted to particularly rapidly.

However, it is also possible to measure the apparent power before and after laser treatment and to calibrate the laser parameters separately to time. For this, samples of the flat steel product can be taken at certain intervals, the apparent power S_{1.7/50} of each of these samples before and after laser treatment can be determined and the parameters of the laser treatment can be varied depending on the results of these measurements. This design permits the method according to the invention to be carried out with comparable process engineering and measurement technology.

Parameters which can be varied in order to optimise the results of the laser treatment include for example the spacing L between the linear deformations, the dwell time t_{dwell} of the laser beam, the specific energy density Uₛ, the laser power P, the focus size is and the scan speed v_{scan}.

Practical tests have shown that to achieve the optimal apparent power S_{1.7/50} it may be expedient to vary the spacing L between the linear deformations in the range from 2-10 mm, in particular 4-7 mm.

A minimisation of the changes to the apparent power S_{1.7/50} occurring as a result of the laser treatment can be achieved by varying the dwell time t_{dwell} of the laser beam in the range from 1×10⁻⁵ s to 2×10⁻⁴ s.

If a fibre laser is used as a laser source, the laser power P can be varied in the fibre lasers currently available in order to minimise the change in apparent power S_{1.7/50} occurring as a result of the laser treatment in the range from 200-3000 W. Fibre lasers have the particular advantage that they enable a narrow focusing of the laser beam. In this way, track widths of less than 20 μm can be achieved with a fibre laser.

However, it is also possible to use a CO₂ laser as the laser source when carrying out the method according to the invention. Due to the fact that with a laser of this type the laser beam cannot be so narrowly focused, in the CO₂ lasers currently available, a variation of the laser power P in the range from 1000-5000 W is indicated for the purpose of minimising the change in the apparent power S_{1.7/50} occurring as a result of the laser treatment.

Of course the method according to the invention is preferably carried out on flat steel products of a type which are coated with at least one insulation layer. In addition to this, a glass or forsterite layer may, for example, be present between the insulation layer and the steel substrate of the flat steel products.

The following examples of a method according to the invention were investigated as evidence of the effect of the invention, whereby:

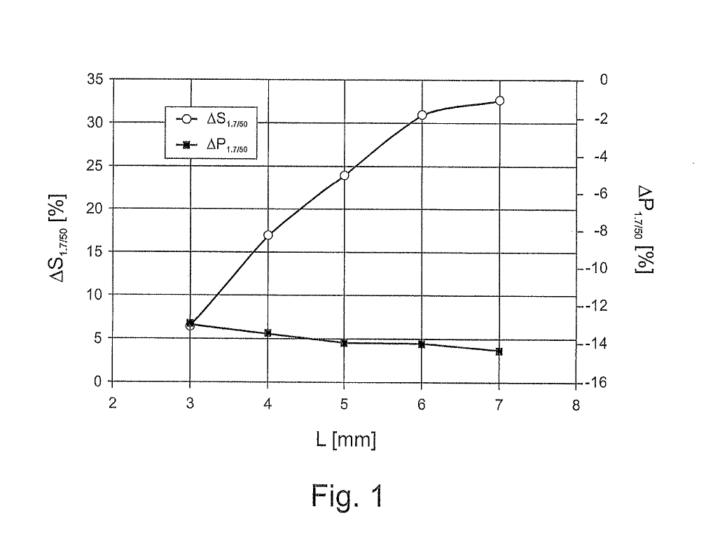

FIG. 1 is a diagram in which the improvement in loss ΔP_{1.7/50} and change in apparent power ΔS_{1.7/50} are spread over the spacing L of the laser tracks;

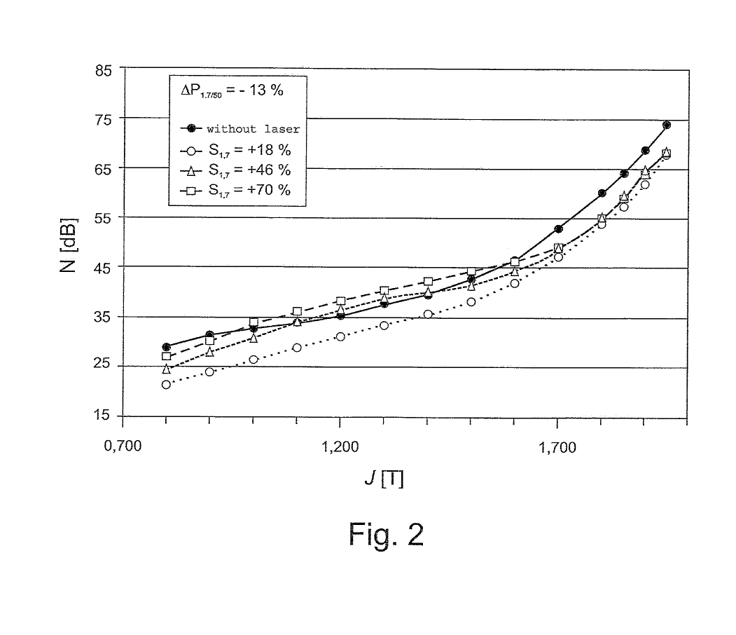

FIG. 2 is a diagram in which the noises N calculated from the measured change in length are shown as a function of the polarisation J.

As part of systematic tests, various parameters of the operative laser equipment were varied with a 1 kW multimode fibre laser. The parameters to be optimised were the spacing L of the laser lines, the laser power P, the focus size Δs and the scan speed v_{scan}.

The empirical assessment of an experimental matrix showed that variations in the above mentioned parameters with clear improvements in the remagnetisation losses could simultaneously effect drastic changes in the apparent power.

As an example, FIG. 1 shows an improvement in loss ΔP_{1.7/50} (symbolised by a filled-in quadrant) and a change in apparent power ΔS_{1.7/50} (symbolised by empty circles) depending on the spacing L between the laser tracks. The changes ΔP_{1.7/50} in power loss P_{1.7/50} and the change ΔS_{1.7/50} in the apparent power S_{1.7/50} as compared to the state before lasering, in other words the state before laser treatment (work step b)) are given as reference values.

By varying the focus size Δs and the scan speed v_{scan}, in other words the speed with which the laser is moved, different length dwell times t_{dwell} of the laser beam on the surface of the flat steel product present as a strip material are generated. The connection between t_{dwell}, Δs and v_{scan} can be described as follows:

t_{dwell}=Δs/v_{scan}

The span of the dwell times of 1×10⁻⁵ seconds to 2×10⁻⁴ seconds results in a certain range with the same level of improvements to remagnetisation losses P_{1.7/50} with differently sized changes in apparent power ΔS_{1.7/50}. It has been shown that with minimised changes in apparent power ΔS_{1.7/50} an optimal noise behaviour of the relevant flat steel product to be treated is set.

The following examples show the influence of the dwell time t_{dwell} on the loss in remagnetisation P_{1.7/50} and apparent power S_{1.7/50}:

Steel strips with a thickness of 0.23 mm were treated with lasers. The dwell time t_{dwell} was varied on the basis of the connections set out above.

The changes ΔP_{1.7/50}, ΔS_{1.7/50} in remagnetisation losses P_{1.7/50} and apparent power S_{1.7/50}, summarised in table 1 below, resulted after measuring the magnetic parameters:

TABLE 1

| | | | | ΔP_{1.7/50} | ΔS_{1.7/50} |
|---|---|---|---|---|---|
| Sample | P [W] | ΔS [mm] | t_{dwell} [s] | [%] | [%] |
| 1 | 900 | 5 | 9.9 × 10⁻⁵ | −12 | +70 |
| 2 | 900 | 5 | 6.6 × 10⁻⁵ | −13 | +46 |
| 3 | 900 | 5 | 3.3 × 10⁻⁵ | −13 | +18 |

The samples were examined below in terms of their magnetostrictive properties, and the noises expected in the course of operation calculated therefrom. In order to calculate the noises from the magnetostriction measurements, a method was used which is described in both the IEC Technical Report IEC 62581 TR and in the publication by E. Reiplinger, “Assessment of grain-oriented transformer sheets with respect to transformer noise”, Journal of Magnetism and Magnetic Materials 21 (1980), 257-261.

FIG. 2 shows the noises N calculated from the change in length measured as a function of polarisation J.

The continuous curve in FIG. 2 is the reference state before laser treatment (“without laser treatment”), wherein the measurement values which form the basis of this curve are symbolised by filled-in black circles.

The dashed line in FIG. 2, the measurement values for which are indicated by empty quadrants, shows the development of noises during laser treatment which led to a change in the apparent power S_{1.7/50} of +70%.

The narrower dashed line in FIG. 2, the measurement values for which are indicated by empty triangles, shows the development of noises during laser treatment which led to a change in the apparent power S_{1.7/50} of +46%.

The dotted line in FIG. 2., the measurement values for which are indicated by empty circles, shows the development of noise during laser treatment in which the parameters of the laser treatment have been selected according to the invention such that the change in apparent power S_{1.7/50} is limited to +18%.

The change ΔP_{1.7/50} in power loss P_{1.7/50} achieved with the laser treatment was in each case −13% compared to the initial state before laser treatment.

The noises calculated using the optimised changes in apparent power achieved according to the invention of ΔS=+18% are therefore always lower than at the outset.

If, however, the apparent power is not taken into consideration, for comparable improvements in loss an increase in noise of 1.1 to 1.5 dB is observed.

It therefore follows from FIG. 2 that with high modulations of the transformers at for example 1.7 Tesla the differences in noise emission between a flat steel product treated according to the invention and a conventionally treated flat steel product are only low. They are, however, still given here systematically. In addition to this, these differences are immediately very apparent with low modulation of the transformers, in other words at low magnetic polarisations.

As the laser parameters according to the invention are optimised such that the difference between the apparent power S_{1.7/50} measured before and after the laser treatment is less than 40%, on the one hand an effective minimisation of the power losses P_{1.7/50} can be achieved, but on the other hand the noise emission during operation can also be minimised. It is irrelevant whether the comparison carried out according to the invention of the values of the apparent power S_{1.7/50} measured before and after the laser treatment takes place online on the continuous strip or is carried out as part of calibrations occurring separately as to time.

1. A method for producing a grain-oriented flat steel product that is intended for the manufacture of parts for electrotechnical applications and has minimised magnetic loss values and optimised magnetostrictive properties, including the operations
a) providing a flat steel product,
b) laser-treating the flat steel product, wherein, in the course of the laser treatment, linear deformations, which are arranged with a spacing L, are formed into the surface of the flat steel product by means of a laser beam emitted by a laser beam source with a power P,
wherein the apparent power S_{1.7/50} of the flat steel product before and after laser treatment (operation b)) at a frequency of 50 Hertz and a polarisation of 1.7 Tesla is measured, and in that the parameters of the laser treatment are varied such that the difference between the apparent power S_{1.7/50} measured before and after treatment is less than 40%.

2. The method according to claim 1, wherein the laser treatment is continuous.

3. The method according to claim 1, wherein the respective apparent power S_{1.7/50} before and after laser treatment in continuous operation is measured online and the parameters of the laser treatment are varied online depending on the difference between the apparent powers S_{1.7/50}.

4. The method according to claim 1, wherein the samples of the flat steel product are taken at certain intervals, the apparent power S_{1.7/50} of each of these samples before and after laser treatment is determined and the parameters of the laser treatment are varied depending on the results of these measurements.

5. The method according to claim 1, wherein the spacing L between the linear deformations, the dwell time t_{dwell} of the laser beam, the specific energy density Uₛ, the laser power P, the focus size Δs or the scan speed v_{scan} are varied as parameters of the laser treatment.

6. The method according to claim 5, wherein the spacing L between the linear deformations is varied in the range from 2-10 mm.

7. The method according to claim 6, wherein the spacing L between the linear deformations is varied in the range from 4-7 mm.

8. The method according to claim 7, wherein the dwell time of the laser beam is varied in the range from 1×10⁻⁵ s to 2×10⁻⁴ s.

9. The method according to claim 7, wherein a fibre laser is used as a laser source and the power P is varied in the range from 200-3000 W.

10. The method according to claim 7, wherein a CO₂ laser is used as a laser source and the power P is varied in the range from 1000-5000 W.

11. The method according to claim 7, wherein the flat steel product is coated with an insulation layer.
